(19) United States
(12) Patent Application Publication
(10) Pub. No.: US 2009/0262636 A1
(43) Pub. Date: Oct. 22, 2009

(54) WIRE-ASSISTED MAGNETIC WRITE DEVICE INCLUDING MULTIPLE WIRE ASSIST CONDUCTORS

(75) Inventors: Jianhua Xue, Maple Grove, MN (US); Yuming Zhou, Lakeville, MN (US); Shaoping Li, Fremont, CA (US); Johannes van Ek, Minnetonka, MN (US); Christopher Rea, Edina, MN (US)

Correspondence Address: KINNEY & LANGE, P.A., 312 SOUTH 3RD STREET, THE KINNEY & LANGE BUILDING, MINNEAPOLIS, MN, 55415, US

(73) Assignee: SEAGATE TECHNOLOGY LLC, Scotts Valley, CA (US)

(21) Appl. No.: 12/105,627

(22) Filed: Apr. 18, 2008

(51) Int. Cl. G11B 9/00

(52) U.S. Cl. 369/126

(57) ABSTRACT

A magnetic device includes a write element including a write element tip, and a conductive coil for carrying a write current to induce a first field in the write element. A first conductor proximate a trailing edge of the write pole tip is operable to carry a first assist current to generate a second field that augments the first field. A second conductor proximate a leading edge of the write pole tip is operable to carry a second assist current to generate a third field that augments the first field. First and second side shields are on opposing sides of the write element in a cross-track direction.

### BACKGROUND

The present invention relates to magnetic devices. More particularly, the present invention relates to a magnetic writer including a conductor that carries a phase shifted current to provide a magnetic field that assists a write field.

As magnetic recording storage densities continue to progress in an effort to increase the storage capacity of magnetic storage devices, magnetic transition (i.e., bit) dimensions and critical features of the recording device are being pushed below 100 nm. This presents a significant challenge in that not only is the magnetic field strength effectively reduced, but the magnetic field profile at the medium is more poorly confined. The result is that off-track fields can cause undesirable effects such as adjacent track or side track erasure. Thus, an important design consideration is to confine the magnetic fields more effectively without significantly degrading the field strength at the medium.

In addition, making the recording medium stable at higher areal densities requires magnetically harder (i.e., high coercivity) storage medium materials. A magnetically harder medium may be written to by increasing the saturation magnetization value of the magnetic material of the recording device to increase the magnetic field applied to the magnetic medium. However, the rate of increase of the saturation magnetization value is not sufficient to sustain the annual growth rate of bit areal densities. Another approach is to provide a stronger write field by incorporating a write assist device adjacent to the tip of the write element that produces a magnetic field to reduce the switching field of the magnetic medium near the write element. This allows data to be written to the high coercivity medium with a lower magnetic field from the write element. However, many current designs of such write assist devices consume high levels of power to generate the assist field, and the cross-track field gradient of the write assist device is poor, which can cause interference on adjacent tracks of the medium.

### SUMMARY

The present invention relates to a magnetic device including a write element having a write element tip, and a conductive coil for carrying a write current to induce a first field in the write element. A first conductor proximate a trailing edge of the write pole tip is operable to carry a first assist current to generate a second field that augments the first field. A second conductor proximate a leading edge of the write pole tip is operable to carry a second assist current to generate a third field that augments the first field. First and second side shields are on opposing sides of the write element in a cross-track direction.

### BRIEF DESCRIPTION OF THE DRAWINGS

FIG. 1 is cross-section view of a magnetic writer including multiple write assist conductors adjacent the write element.

FIG. 2 is a front surface view of the magnetic writer shown in FIG. 1 including side shields on opposing sides of the write element in a cross-track direction.

FIG. 3 is a graph of the normalized down-track and effective fields for magnetic writers with and without side shields.

### DETAILED DESCRIPTION

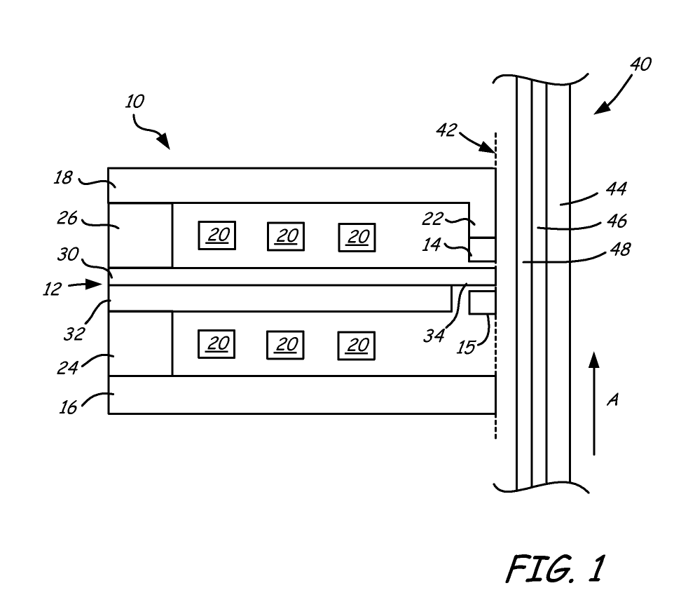

FIG. 1 is a cross-section view of magnetic writer 10, which includes write pole assembly (or write element) 12, first write assist conductor 14, second write assist conductor 15, first return pole or element 16, second return pole or element 18, and conductive coil 20. Write pole assembly 12 is magnetically coupled to first return pole 16 by first magnetic stud 24, and to second return pole 18 by second magnetic stud 26. Conductive coil 20 surrounds write pole assembly 12 such that portions of conductive coil 20 are disposed between write pole assembly 12 and first return pole 16, and between write pole assembly 12 and second return pole 18. Trailing shield 22 extends from second return pole 18 toward first write assist conductor 14. Write pole assembly 12 includes write pole body 30 and yoke 32, and write pole body 30 includes write pole tip 34.

First return pole 16, second return pole 18, first magnetic stud 24, and second magnetic stud 26 may comprise soft magnetic materials, such as NiFe. Conductive coil 20 may comprise a material with low electrical resistance, such as Cu. Write pole body 30 may comprise a high moment soft magnetic material, such as CoFe, and yoke 32 and shield 22 may comprise a soft magnetic material, such as NiFe, to improve the efficiency of flux delivery to write pole body 30.

Magnetic writer 10 confronts magnetic medium 40 at front surface 42 defined by write pole tip 34, first return pole 16, and second return pole 18. Magnetic medium 40 includes substrate 44, soft underlayer (SUL) 46, and medium layer 48. SUL 46 is disposed between substrate 44 and medium layer 48. Magnetic medium 40 is positioned proximate to magnetic writer 10 such that the surface of medium layer 48 opposite SUL 46 faces write pole assembly 12. Magnetic medium 40 is shown merely for purposes of illustration, and may be any type of medium usable in conjunction with magnetic writer 10, such as composite media, continuous/granular coupled (CGC) media, discrete track media, and bit-patterned media.

Magnetic writer 10 is carried over the surface of magnetic medium 40, which is moved relative to magnetic writer 10 as indicated by arrow A such that write pole assembly 12 trails first return pole 16, leads second return pole 18, and is used to physically write data to magnetic medium 40. In order to write data to magnetic medium 40, a current is caused to flow through conductive coil 20. The magnetomotive force in conductive coil 20 causes magnetic flux to travel from write pole tip 34 perpendicularly through medium layer 48, across SUL 46, and through first return pole 16 and first magnetic stud 24 to provide a first closed magnetic flux path. The direction of the write field at the medium confronting surface of write pole tip 34, which is related to the state of the data written to magnetic medium 40, is controllable based on the direction that the first current flows through first conductive coil 20.

Stray magnetic fields from outside sources, such as a voice coil motor associated with actuation of magnetic writer 10 relative to magnetic medium 40, may enter SUL 46. Due to the closed magnetic path between write pole assembly 12 and first return pole 16, these stray fields may be drawn into magnetic writer 10 by first return pole 16. In order to reduce or eliminate these stray fields, second return pole 18 is connected to write pole assembly 12 via second magnetic stud 26 to provide a flux path for the stray magnetic fields. The stray fields enter first return pole 16, travels through first magnetic stud 24 and second magnetic stud 26, and exits magnetic writer 10 via second return pole 18.

Magnetic writer 10 is shown merely for purposes of illustrating an example construction that may be used in conjunction with the principles of the present invention, and variations on this design may be made. For example, while write pole assembly 12 includes write pole body 30 and yoke 32, write pole assembly 12 can also be comprised of a single layer of magnetic material. In addition, a single trailing return pole 18 may be provided instead of the shown dual return pole writer configuration. Furthermore, while conductive coils 20 are shown formed around write pole assembly 12, conductive coils 20 may alternatively be formed around either or both of magnetic studs 24 and 26.

To write data to high coercivity medium layer 48, a stronger write field may be provided to impress magnetization reversal in the medium. To accomplish this, first write assist conductor 14 is provided proximate magnetic medium 40 and the trailing side of write pole tip 34, and second write assist conductor 15 is provided proximate magnetic medium 40 and the leading side of write pole tip 34. When a current is applied to write assist conductors 14 and 15, an assist magnetic field is generated by each write assist conductor that augments the write field produced by write pole assembly 12. The combination of the write field generated by write pole assembly 12 and the assist fields generated by write assist conductors 14 and 15 overcomes the high coercivity of medium layer 48 to permit controlled writing of data to magnetic medium 40. In addition, conductors 14 and 15 improve the write field gradient of magnetic writer 10, which provides for a stronger, more focused write field proximate to write pole tip 34. The improved write field gradient reduces the likelihood of side writing on adjacent tracks of magnetic medium 40 and reduces the size of the written track.

Write assist conductors 14 and 15 are shown at front surface 42, but it will be appreciated that write assist conductors 14 and 15 may alternatively be formed recessed from front surface 42, or one of write assist conductors 14 and 15 may be formed at front surface 42 with the other of write assist conductors 14 and 15 recessed from front surface 42. The positioning of write assist conductors 14 and 15 may be adjusted to provide a field gradient profile that maximizes the write assist field in magnetic medium 40 below write pole tip 34 while minimizing stray fields.

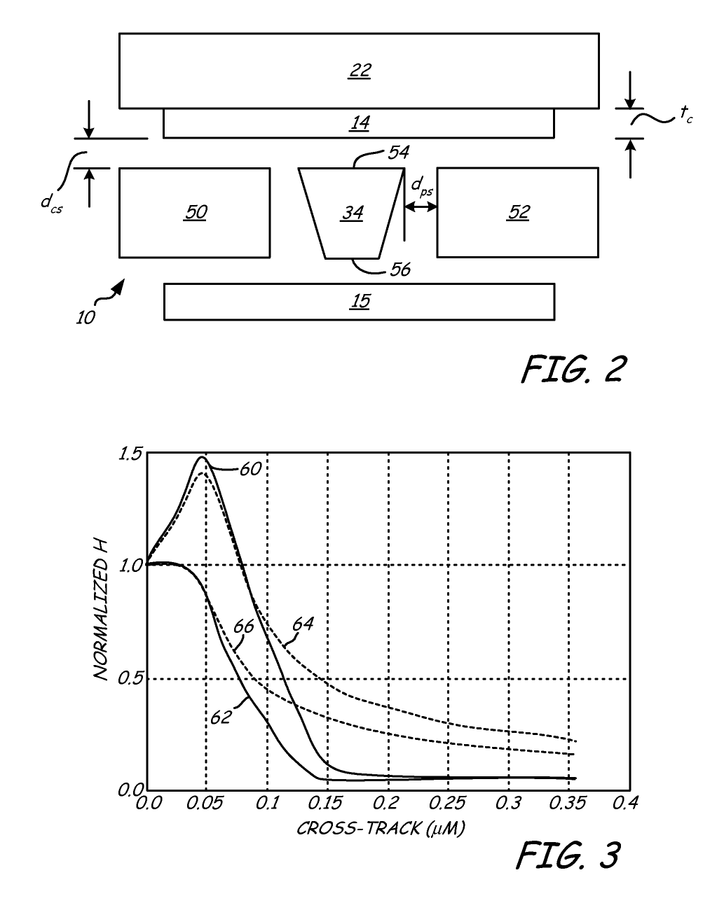

FIG. 2 is a front surface view of magnetic writer 10 including first side shield 50 and second side shield 52 on opposing sides of write element tip 34. Also shown in FIG. 2 are first write assist conductor 14, second write assist conductor 15, and trailing shield 22. First write assist conductor 14 is adjacent trailing edge 54 of write pole tip 34, and second write assist conductor 15 is adjacent leading edge 15 of write pole tip 34. In some embodiments, a nonmagnetic material fills the space between write assist conductors 14 and 15 and write pole tip 34. First write assist conductor 14 may be adjacent trailing shield 22 as shown in FIG. 2. Alternatively, first write assist conductor 14 may be spaced from trailing shield 22 as shown in FIG. 1. First write assist conductor 14 and second write assist conductor 15 have a down-track thickness t_{c} which, in some embodiments, is in the range of about 100 nm to about 2,000 nm.

Write pole tip 34 may have a substantially trapezoidal shape at front surface 42. The substantially trapezoidal shape decreases the dependence of the track width recorded by write pole assembly 12 on the skew angle of magnetic writer 10, which varies as magnetic writer 10 travels in an arc across magnetic medium 40. This improves the recording density of magnetic writer 10 and reduces the bit error rate and side writing and erasure on adjacent tracks of magnetic medium 40. It should be noted that while write pole tip 34 is shown having a trapezoidal shape, write pole tip 34 may alternatively have any shape at magnetic medium 40 that is capable of generating a write field at magnetic medium 40 during the write process.

Write pole assembly 12 is spaced from side shields 50 and 52 by separation distance dₚₛ. In some embodiments, separation distance dₚₛ is in the range of about 20 nm to about 300 nm. Side shields 50 and 52 are also spaced from first write assist conductor 14 and second write assist conductor 15 by separation distance d_{cs}. In some embodiments, separation distance d_{cs} is in the range of about 20 nm to about 200 nm. Write pole assembly 12, side shields 50 and 52, and write assist conductors 14 and 15 may be electrically isolated from each other with an insulating material such as Al₂O₃, SiN, or SiO₂.

Side shields 50 and 52 are disposed on opposing sides of write pole assembly 12 in a cross-track direction. In some embodiments, side shields 50 and 52 are comprised of a soft magnetic material, such as NiFe. Side shields 50 and 52 confine the write field generated by write pole assembly 12 and the assist fields generated by write assist conductors 14 and 15 in the cross-track direction. This prevents side writing and erasure of data on tracks adjacent to the track being written to by magnetic writer 10. Consequently, the magnitude of the combined write and write assist fields drops off more quickly in the cross-track direction from the center of write pole tip 34, which results in an improved field gradient in the cross-track direction.

FIG. 3 is a graph of the normalized down-track and effective fields for magnetic writers with and without side shields. In particular, line 60 plots the normalized effective field H_{eff} (i.e., the total combined write and write assist fields) versus cross-track position, and line 62 plots the normalized perpendicular field H_{y} (i.e., the field component extending between write pole assembly 12 and magnetic medium 40) versus cross-track position, for magnetic writer 10 with side shields 50 and 52. For comparison, line 64 plots the normalized effective field H_{eff} versus cross-track position, and line 66 plots the normalized perpendicular field H_{y} versus cross-track position, for magnetic writer 10 without side shields 50 and 52. For all lines, the cross-track center of write pole tip 34 is plotted at 0.0 μm in the graph. As is shown, magnetic writer 10 with side shields 50 and 52 provides an increased peak effective field H_{eff}, as well as a sharper drop off in effective write field H_{eff} and perpendicular field H_{y} with increased cross-track distance from the center of write pole tip 34. Due to the decreased field in the cross-track direction, the field gradient is improved and side writing and erasure is reduced.

In summary, the present invention relates to a magnetic device including a write element having a write element tip, and a conductive coil for carrying a write current to induce a first field in the write element. A first conductor proximate a trailing edge of the write pole tip is operable to carry a first assist current to generate a second field that augments the first field. A second conductor proximate a leading edge of the write pole tip is operable to carry a second assist current to generate a third field that augments the first field. First and second side shields are on opposing sides of the write element in a cross-track direction. By incorporating multiple write assist conductors and side shields into the writer assembly, the field gradient of the magnetic device is improved, thereby reducing the width of the recorded track (i.e., improving track density) and reducing deleterious writing and erasure of adjacent tracks.

Although the present invention has been described with reference to preferred embodiments, workers skilled in the art will recognize that changes may be made in form and detail without departing from the spirit and scope of the invention.

1. A magnetic device comprising:
a write element including a write element tip;
a conductive coil for carrying a write current to induce a first field in the write element;
a first conductor proximate a trailing side of the write pole tip for carrying a first assist current to generate a second field that augments the first field;
a second conductor proximate a leading side of the write pole tip for carrying a second assist current to generate a third field that augments the first field; and
first and second side shields on opposing sides of the write element tip in a cross-track direction.

2. The magnetic device of claim 1, wherein at least one of the first and second conductors is comprised of a material selected from the group consisting of Au, Cu, and Ag.

3. The magnetic device of claim 1, wherein the first and second side shields are separated from the write element by a nonmagnetic gap.

4. The magnetic device of claim 1, wherein the first and second side shields are comprised of a magnetic material.

5. The magnetic device of claim 1, and further comprising:
a trailing shield on a side of the second conductor opposite the trailing side of the write pole tip.

6. The magnetic device of claim 5, wherein the trailing shield extends from a return element magnetically coupled to the write element.

7. The magnetic device of claim 1, wherein the first and second conductors are separated from the first and second side shields by a distance in the range of about 20 nm to about 200 nm.

8. The magnetic device of claim 1, wherein the first and second conductors have a down-track thickness in the range of about 100 nm to about 2,000 nm.

9. The magnetic device of claim 1, wherein the first and second side shields are separated from the write element by between about 20 nm and 300 nm.

10. A magnetic writer comprising:
a write element operable to generate a write field at a front surface;
a first return element magnetically coupled to the write element distal from the front surface on a trailing side of the write element;
a first conductor proximate a trailing side of the write element at the front surface for carrying a first assist current to generate a first assist field that augments the write field;
a second conductor proximate a leading side of the write element at the front surface for carrying a second assist current to generate a second assist field that augments the write field; and
first and second side shields on opposing sides of the write element in a cross-track direction.

11. The magnetic writer of claim 10, and further comprising:
a second return element magnetically coupled to the write element distal from the front surface on the leading side of the write element.

12. The magnetic writer of claim 10, and further comprising:
a trailing shield extending from the first return element to the second conductor.

13. The magnetic writer of claim 10, wherein the first and second side shields are comprised of a magnetic material.

14. The magnetic writer of claim 10, wherein the first and second side shields are separated from the write element by a nonmagnetic gap.

15. A magnetic writer comprising:
a write element operable to generate a write field at a front surface;
a plurality of write assist conductors proximate the write element at the front surface, wherein each write assist conductor is operable to generate an assist field that augments the write field; and
first and second side shields on opposing sides of the write element in a cross-track direction.

16. The magnetic writer of claim 15, and further comprising:
a first return element magnetically coupled to the write element distal from the front surface on a trailing side of the write element.

17. The magnetic writer of claim 16, and further comprising:
a trailing shield extending from the first return element toward the write element at the front surface.

18. The magnetic writer of claim 15, wherein the first and second side shields are comprised of a magnetic material.

19. The magnetic writer of claim 15, wherein the write assist conductors are separated from the first and second side shields by a distance in the range of about 20 nm to about 200 nm.

20. The magnetic writer of claim 15, wherein the first and second side shields are separated from the write element by a nonmagnetic gap.
